(19) United States
(12) Patent Application Publication
(10) Pub. No.: US 2016/0373384 A1
(43) Pub. Date: Dec. 22, 2016

(54) SYSTEM AND METHOD FOR INSTANT MESSAGING

(71) Applicant: IdealOne Technology Limited, Hong Kong (HK)

(72) Inventors: Chi Man Dominic Lun, Hong Kong (HK); Wing Hon Tsang, Hong Kong (HK); Ho Sang Lam, Hong Kong (HK)

(21) Appl. No.: 15/250,904

(22) Filed: Aug. 29, 2016

Related U.S. Application Data
(63) Continuation of application No. PCT/CN2015/086484, filed on Aug. 10, 2015.

(30) Foreign Application Priority Data
Aug. 8, 2014 (HK) 14108178.1

(51) Int. Cl. H04L 12/58; G06F 17/30; H04W 4/00; H04L 29/08; H04L 5/00

(52) U.S. Cl. CPC H04L 51/04; H04L 67/02; H04L 67/22; H04L 5/0055; H04L 67/36; H04W 4/008; G06F 17/30345

(57) ABSTRACT

A network includes: at least a user terminal; a chat server; and at least a system for instant messaging. The system includes: a processor; memory; a chat engine; a control logic unit; and an input and output interface. The user terminal, the chat server, and the system are in communication with each other through instant messaging. A first user terminal is configured to send a message to a second user terminal indicating lack of privacy of the first user terminal when a first user of the first user terminal is logged in to the first user terminal, the first user being preregistered with a second user of the second user terminal. The second user terminal is configured to send a message to a third user and thereby notifying the third user of the lack of privacy of the first user terminal. A method for instant messaging is also provided.

### CROSS-REFERENCE TO RELATED APPLICATIONS

The present application is a Continuation Application of PCT application No. PCT/CN2015/086484 filed on Aug. 10, 2015, which claims the benefit of Hong Kong Patent Application No. 14108178.1 filed on Aug. 8, 2014, the contents of which are hereby incorporated by reference.

### FIELD OF THE PATENT APPLICATION

The present patent application generally relates to information technologies and more specifically to a system and a method for instant messaging.

### BACKGROUND

Instant messaging is a computer communication tool that enables two or more than two users to exchange text, files, audios and videos through computer networks in real time. Conventionally, an instant messaging system only allows two users each having a computer terminal to communicate with each other. It is desired to have a system by which a user can control a machine, such as a home appliance, through instant messaging while different machines can take the behaviors of each other as a reference through instant messaging and become more adaptive to the user's behaviors and habits.

### SUMMARY

The present patent application is directed to a system and a method for instant messaging. In one aspect, the present patent application provides a network that includes: at least a user terminal; a chat server; and at least a system for instant messaging. The system includes: a processor; memory; a chat engine; a control logic unit; and an input and output interface. The user terminal, the chat server, and the system are in communication with each other through instant messaging.

A first user terminal is configured to send a message to a second user terminal indicating lack of privacy of the first user terminal when a first user of the first user terminal is logged in to the first user terminal, the first user being preregistered with a second user of the second user terminal. The second user terminal is configured to send a message to a third user and thereby notifying the third user of the lack of privacy of the first user terminal.

The system may further include a behavior database, while the input and output interface may include a network interface connection and at least one of a sensor, an actuator, a button and a display. The control logic unit may be configured to perform a function through the input and output interface and update parameters in the behavior database. The system may further include a web server, wherein the web server is configured to provide a web format page for detail reporting or summary.

The chat engine may include a string pattern matching, a string response generator, a command generator and a knowledge database. The string pattern matching engine may be an input engine configured to match an input entity of the knowledge database, while the string response generator may be configured to generate a human comprehendible response based on an output of the knowledge database.

The command generator may be configured to generate a high-level command based on an output of the knowledge database and send the high-level command to the control logic unit. The control logic unit may be configured to accept the high-level command from the command generator, and to control the system with parameters in the behavior database. The behavior database may be initially filled with default values, and then updated to be tracking behavior of a user or another system in the network. The knowledge database may include a plurality of records, each record having attributes that include: Translation Key, Input Templates, Matching Schemes, Contexts, Responses Templates, and Commands. The behavior database may include a plurality of records, each record having attributes that include: Group Name, User Name, Triggering Source, Triggering Action, Weekday and weekend, Time Section, Last action time, Response action, Response action delay time, Response action value, Time out of learning, and Learning step size. After the control logic posts a message to the chat server, the system may be configured to neglect the message sent by itself.

When a user sends a message to the system, the system may be configured to respond with a message as an acknowledgement. If the message can generate a command, the control logic unit may be configured to perform a function at the actuator, update the behavior database, and send a simple message to the string pattern matching engine; if the received message cannot generate a command, the control logic unit may be configured to send a simple message to the string pattern matching engine so as to generate a command option message to remind the user.

When a user sends a message to the chat server, if the message cannot generate a command, the system may be configured to not post any message and keep silent; otherwise, the system may be configured to perform its action using parameters in the behavior database and post a message to the chat server.

In another aspect, the present patent application provides a system for instant messaging that includes: a chat engine; a control logic unit; a behavior database; and an input and output interface. The control logic unit is configured to perform a function through the input and output interface and update parameters in the behavior database. The chat engine includes a string pattern matching, a string response generator, a command generator and a knowledge database. The string pattern matching engine is an input engine configured to match an input entity of the knowledge database, while the string response generator is configured to generate a human comprehendible response based on an output of the knowledge database. The command generator is configured to generate a high-level command based on an output of the knowledge database and send the high-level command to the control logic unit. The control logic unit is configured to accept the high-level command from the command generator, and to control the system with parameters in the behavior database.

The knowledge database may include a plurality of records, each record having attributes that include: Translation Key, Input Templates, Matching Schemes, Contexts, Responses Templates, and Commands. The input and output interface may include a network interface connection and at least one of a sensor, an actuator, a button, and a display.

In yet another aspect, the present patent application provides a method for instant messaging. The method includes: matching an input entity of a knowledge database by a string pattern matching engine; generating a human comprehendible response based on an output of the knowledge database by a string response generator; generating a high-level command based on an output of the knowledge database and sending the high-level command to a control logic unit by a command generator; and accepting the high-level command from the command generator, performing a function through an input and output interface with parameters in a behavior database, and updating parameters in the behavior database by the control logic unit.

The method may further include initially filling the behavior database with default values, and then updating the behavior database to track behavior of a user. The behavior database may include a plurality of records, each record having attributes that include: Group Name, User Name, Triggering Source, Triggering Action, Weekday and weekend, Time Section, Last action time, Response action, Response action delay time, Response action value, Time out of learning, and Learning step size.

In still another aspect, the present patent application provides a system for instant messaging that includes: at least a user terminal and at least a machine. Each user terminal and each machine are respectively installed with an instant messaging client. The user terminal and the machine are configured to communicate with each other by their respective instant messaging clients through instant messaging.

The system may further include a plurality of machines, wherein the machines are configured to communicate with each other by their respective instant messaging clients through instant messaging. The user terminal may include a binary data transmitter configured to transmit binary data to the machine by the instant messaging client of the user terminal. The machine may include a binary data receiver configured to receive binary data from the user terminal by the instant messaging client of the machine.

The user terminal may further include an input device configured to allow a user to input text or audio. The binary data transmitter may be configured to transmit binary data converted from the text or audio input by the user.

Each machine may include a binary data transmitter configured to transmit binary data to another machine by the instant messaging client of the machine; and a binary data receiver configured to receive binary data from another machine by the instant messaging client of the machine. The machine may further include a syntax interpreter configured to interpret syntax of the binary data received by the binary data receiver, and retrieve abstract meaning of text represented by the binary data. The binary data may represent human natural language symbols. The human natural language symbols may be 16 bit unicodes. The human natural language symbols may include English or Chinese symbols.

When the user terminal communicates with the machine, the user terminal may be configured to transmit a request, and the machine may be configured to automatically generate a response message responding to the request. The machine may be configured to learn from history data transmitted from the user terminal through an artificial intelligence engine, and automatically generate a response message responding to the request.

Before the user terminal communicates with the machine, a user registers the machine through the instant messaging client of the user terminal, and the machine may be configured to register the user through the instant messaging client of the machine; before the machine communicates with another machine, the machine may be configured to register the other machine through the instant messaging client of the machine. The instant messaging client of the user terminal may be configured to allow the user to register other users. A first user terminal may be a user terminal with multiple users. After a first user of the first user terminal logs in the instant messaging client of the first user terminal, the first user terminal may be configured to send a message to a second user terminal indicating that the first user is one of the multiple users of the first user terminal; a second user of the second user terminal may be registered with the first user of the first user terminal; the second user of the second user terminal may be notified by the message of lack of privacy of the first user terminal.

The system may further include a router or a server configured to collect response of the at least one machine to the user terminal. The user terminal may be configured to check and verify the response of the machine to the user terminal by logging into the router or server. The user terminal may be configured to modify the response of the machine to the user terminal by logging into the router or server. The router or server may be configured to notify the machine of the response modified by the user terminal.

The system may further include a LED indicator configured to indicate status of the machine. The system may further include a buzzer and a microphone configured to transmit and receive ultrasound, and form ultrasound communication links between the machines by ultrasound.

The user terminal may be configured to communicate with the machine through WiFi, Bluetooth, or a mobile network wirelessly, or by a physical wire. The machine may be a home appliance, office appliance, mechanical apparatus or a transportation tool. The system may further include at least a protocol language translation engine device configured to translate protocol language of data transmitted to the user terminal or the machine, when the data is not recognized by the user terminal or the machine during communication between the user terminal and the machine or between the machines.

The protocol language translation engine device may include a transceiver configured to, during communication between the user terminal and the machine or between the machines, receive data transmitted by one side, and transmit protocol language translated data to the other side.

The at least one user terminal, the at least one machine, and the at least one protocol language translation engine device may form a plurality of device groups. Each device group may include a group of main devices. Different groups of main devices may be configured to communicate with each other. A device in each device group may be connected with an external cloud server, and configured to communicate with other device groups through the Internet. Protocols that the protocol language translation engine device is configured to translate may include Zigbee protocol and Bluetooth protocol.

### BRIEF DESCRIPTIONS OF THE DRAWINGS

FIG. 1 is a block diagram illustrating a system for instant messaging in accordance with an embodiment of the present patent application.

FIG. 2 illustrates a network environment for a system for instant messaging in accordance with an embodiment of the present patent application.

FIG. 3 illustrates that a message flow is initialized by a sensor in a system for instant messaging in accordance with an embodiment of the present patent application.

FIG. 4 illustrates that a message flow is initialized by a control logic unit in a system for instant messaging in accordance with an embodiment of the present patent application.

FIG. 5 illustrates that a message flow is initialized by a user via buttons in a system for instant messaging in accordance with an embodiment of the present patent application.

FIG. 6 illustrates that a message flow is initialized by a chat terminal in communication with a system for instant messaging in accordance with an embodiment of the present patent application.

FIG. 7 illustrates that a message flow is initialized by an external information server in a system for instant messaging in accordance with an embodiment of the present patent application.

FIG. 8 is a flow chart illustrating different message types and message flows in accordance with another embodiment of the present patent application.

FIG. 9 is a flow chart illustrating an example of a curtain cooperating with a clock alarm enabled by a system for instant messaging in accordance with an embodiment of the present patent application.

FIG. 10 is a block diagram of a system for instant messaging in accordance with an embodiment of the present patent application.

FIG. 11 is another block diagram of a system for instant messaging in accordance with an embodiment of the present patent application.

FIG. 12 is another block diagram of a system for instant messaging in accordance with an embodiment of the present patent application.

FIG. 13 is another block diagram of a system for instant messaging in accordance with an embodiment of the present patent application.

FIG. 14 is another block diagram of a system for instant messaging in accordance with an embodiment of the present patent application.

### DETAILED DESCRIPTION

Reference will now be made in detail to a preferred embodiment of the system and the method for instant messaging disclosed in the present patent application, examples of which are also provided in the following description. Exemplary embodiments of the system and the method for instant messaging disclosed in the present patent application are described in detail, although it will be apparent to those skilled in the relevant art that some features that are not particularly important to an understanding of the system and the method for instant messaging may not be shown for the sake of clarity.

Furthermore, it should be understood that the system and the method for instant messaging disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

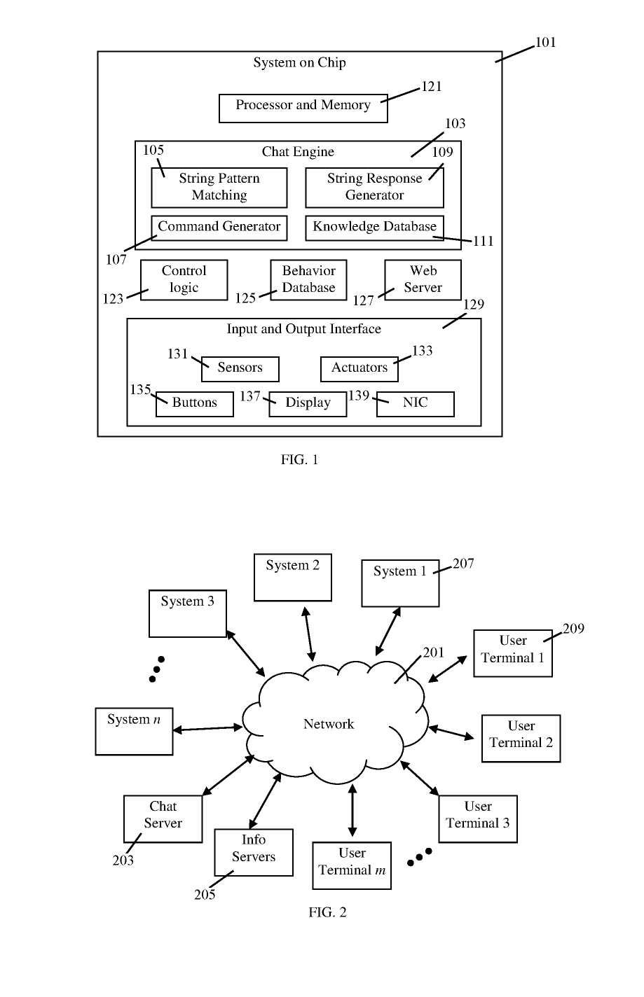

FIG. 1 is a block diagram illustrating a system for instant messaging in accordance with an embodiment of the present patent application. Referring to FIG. 1, the system 101 is a system on chip. The chip includes a processor, a memory, and specific functional units (memory management, graphic engine, controllers, and various input and output interfaces to connect with external or internal hardware modules or devices). Besides the processor and the memory 121, the system 101 includes a chat engine 103, a control logic unit 123, a behavior database 125, a web server 127, and an input and output interface 129.

The chat engine 103 is modified and simplified from existing engines such as one written in AIML (artificial intelligent markup language). The chat engine 103 includes a string pattern matching engine 105, a string response generator 109, a command generator 107 and a knowledge database 111. The string pattern matching engine 105 is an input engine to match the input entity of the knowledge database 111. The string response generator 109 is configured to generate a human quality-like (human comprehendible) response based on the output of the knowledge database 111. In order to control the system by using chat, the knowledge database 111 is configured to additionally output a command for the system such as pushing a button on the user panel of the system. The command generator 107 is configured to generate a high-level command based on the output of the knowledge database and send the high-level command to the control logic unit 123. The control logic unit 123 is configured to accept the high-level command from the command generator 107 and to control the system with the parameters in the behavior database 125. The behavior database 125 is initially filled with the default values. After that, the behavior database 125 will be changed (i.e. updated) to be tracking the user's favor, habits or behaviors and other systems' behaviors which will be described in more detail hereafter to utilize the cooperation. The input and output interface 129 includes at least a sensor 131, at least an actuator 133, at least a button 135, a display 137, and a NIC 139. The sensor 131 is configured to detect different physical quantity changes in the external and internal of the system. Usually smart system has different types of sensors. The actuator 133 is configured to generate different physical contents such as motion, sound, heat, wind, light, and etc. The buttons 135 are user input devices just like a computer keyboard configured to input high-level command into the system. The buttons 135 can be on-screen buttons using cap-sensing or screen menu driven buttons. The display 137 is a device configured to show the system's information and status for the user. The NIC 139 is a network interface connection configured to connect different types of networks using various protocols and physical media for communication. The web server 127 is an optional server configured to provide a web format page for detail reporting or summary instead of using a chat message.

FIG. 2 illustrates a network environment for a system for instant messaging in accordance with an embodiment of the present patent application. Referring to FIG. 2, the network 201 includes a plurality of systems and terminals physically connected together for communicating with each other. The network 201 can be formed into different topologies using wired or wireless means, such as token ring, bus, tree, mesh, star, and etc. with Ethernet, Internet, WiFi, and other protocols. The chat server 203 is a common place to post the chat message and let all the clients in this group share the chat messages. For example, the server can be a Whatsapp server, a WeChat server, and so on. Each client can join more than one chat server 203. The info servers 205 are configured to provide useful information in a message format and post the message to the chat server 203, such as weather, police warning, travel news, and etc. To facilitate the communication, all the clients in the network group, including the systems 207 in this embodiment and the user terminals 209, should have their unique identities and names and let each other know by whom the message is sent out. For the systems according to this embodiment, they should additionally have a machine type, brief functional description and etc. to enhance the cooperation among the machines. A low level network setup is necessary to let each one of the systems join together.

In this embodiment, a first user terminal is configured to send a message to a second user terminal indicating lack of privacy of the first user terminal when a first user of the first user terminal is logged in to the first user terminal, the first user being preregistered with a second user of the second user terminal. The second user terminal is configured to send a message to a third user and thereby notifying the third user of the lack of privacy of the first user terminal. For example, a first user terminal A has users 1, 2, and 3, while a second user terminal B has a user 4. The user 1 is preregistered with the user 4, i.e. the user 1 has been added by the user 4 as a friend. When the user 1 is logged in to the first terminal A, the first terminal A is configured to send a message to the second user terminal B, indicating that the user 1 is one of the multiple users of the first user terminal A, and by receiving the message, the second user terminal B is notified that the first user terminal A lacks privacy. The user 4 can use the second user terminal B to send messages to other users and thereby notifying them that the first user terminal A lacks privacy.

In this embodiment, the grouping strategy is up to the specific operation situation so that the system can easily be controlled by group messages and enhanced in cooperation. For example, for home appliances, a user can group the appliances by location such as bedroom, kitchen, and etc. Another grouping strategy may be by functions such as temperature (cooler, heater, fan, humidifier, window, and etc.), lighting (ceiling, wall lamp, floor lamp, spotlight, curtain, and etc.), and so on. On the other hand, systems provided by this embodiment can also identity its neighbor devices and function as a group for cooperation by the sensor responses. For example, for home appliances, if every device (system provided by this embodiment) has its PIR (passive infrared) sensor then when the user walks into an area, all the devices will send out a response message about the PIR triggered. Then the systems will know that they are present within an area. As another example, lighting change and temperature change response messages also let the devices know that they have similar functions.

The knowledge database 111 can be presented as a table array, which is fixed at the time of design and won't be updated in running time (i.e. read only). The column is attributes and the row is the entry of a record so the attribute set of each record is the same. In order to facilitate the database's update and manipulation, a subset of the attributes can be grouped and forming another table to reduce the reply or redundant data, by placing an index in the original flat table (or database) replacing the subset of the attributes. This process is called database normalization and the table of table structure is called database schema. The database presented here is a flat structure. It is understood that the database can be translated to another schema while not limiting the usage of the system.

In this embodiment, the knowledge database 111 includes a plurality of records, while each record has attributes that include: Translation Key, Input Templates, Matching Schemes, Contexts, Responses Templates, and Commands. The translation Key is a unique number as a key for searching in the different knowledge databases with other languages. For example, the chat engine can handle three languages: English, Traditional Chinese, and Simplified Chinese. If the user selects Traditional Chinese or the system default is outputting Traditional Chinese, then for an English language input, the system will search in the English database for a best matching entry and get the Translation Key. Afterwards, the system uses this key to go to the Chinese database to retrieve and output a Chinese message as its response. Therefore, there are three identical knowledge databases in three different languages.

The Input Templates is a set of words or phase of words to represent the same or similar meaning for the system. For example, “Hi”, “Hello”, “How are you”, and “How do you do”, they all have similar greeting meaning. Matching Schemes is a set of filtering strategy for the input string matching so that it can catch the meaning of the input string more precisely with the Input Template. Matching Schemes, for example, includes keyword matching, phrase matching, longer string matching, conditional position matching for keyword, conditional position matching for phrases, and etc. Contexts is a set of preconditions related to the just past chat conversation, cooperating device, and timing.

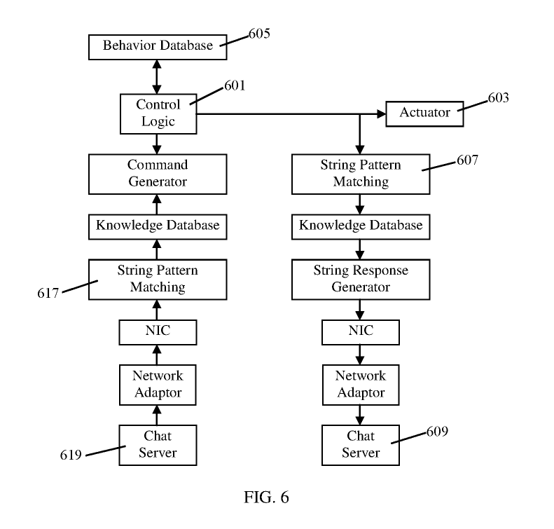

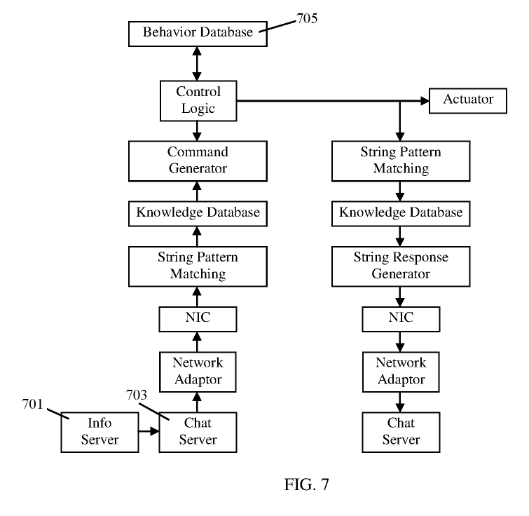

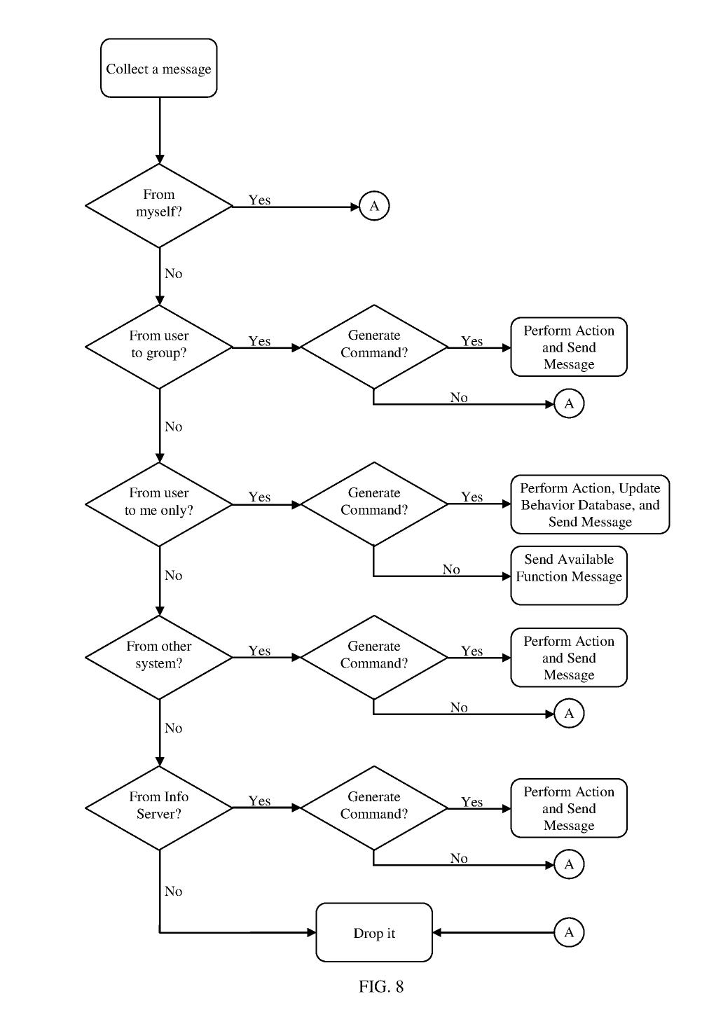

After the input message string fulfills the Input Templates, Matching Schemes and Contexts, one of response strings will be chosen in a shuffling manner in a set of similar response strings, which is included in the Response Templates. There will be another set of responses for a different gender in some country languages. Whether there is an output depends on different situations depicted in FIG. 8. If this response associates with a high-level command, the command is sent to the control logic unit and the control logic unit will use the Response Templates to composite a simple input string for the Chat Engine to generate and post an output message on the chat server as illustrated in FIG. 6 and FIG. 7.

The attribute Commands includes one high-level command or a sequence of high-level commands sent to the Control logic unit.

The behavior database 125 includes records to memorize the user preferences based on individual groups and users. It is not like the knowledge database 111 and it is created at the running time. Its attributes may include but are not limited to:
1. Group Name: each device can be assigned to more than one group;
2. User Name: it is useful for a coffee maker, for instance;
3. Triggering Source: the user or other devices;
4. Triggering Action: for example, on, off, stop, etc.;
5. Weekday and weekend;
6. Time Section: Morning, afternoon, or evening;
7. Last action time;
8. Response action: it is a command for the device itself;
9. Response action delay time (default zero values);
10. Response action value (default zero values);
11. Time out of learning: it may be chosen to be a fixed value or double of the Response action delay time;
12. Learning step size: per day or per time.

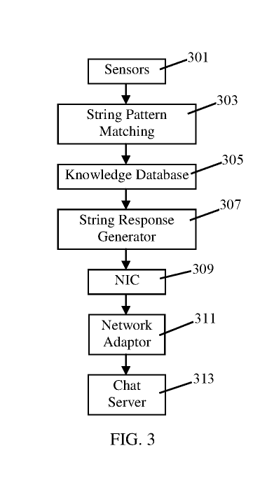

FIG. 3 illustrates that a message flow is initialized by a sensor in a system for instant messaging in accordance with an embodiment of the present patent application. Referring to FIG. 3, the sensor 301 captures a physical quantity change and the control logic unit sends a simple message that contains the value to the string pattern matching engine 303, for example, “increase to 30 degree Celsius”. Then the string response generator 307 uses the output of the knowledge database 305 for the message template to composite a message with the value, for example, “The temperature rises to 30 degree Celsius or 86 degree Fahrenheit.” This message will be looped back to the sending system but the sending system will neglect this message because it knows that the message is sent from itself. As aforementioned, in this embodiment, the control logic unit is configured to send a simple message to the string pattern matching engine so as to generate a command option message to remind the user.

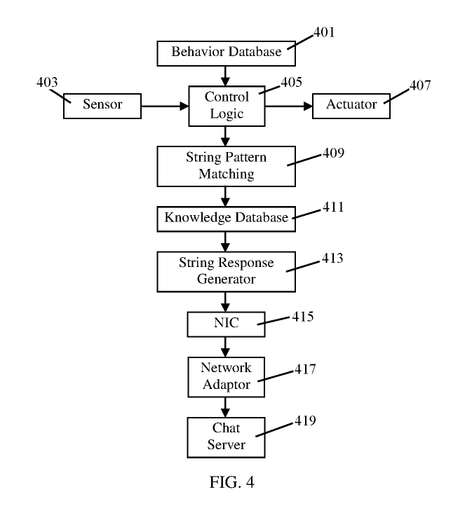

FIG. 4 illustrates that a message flow is initialized by the control logic unit in a system for instant messaging in accordance with an embodiment of the present patent application. Referring to FIG. 4, when the control logic unit 405 is automatically (upon receiving a signal from the sensor 403 for example) taking action to perform its function via its actuator 407, the parameters being used are retrieved from the behavior database 401. The control logic unit 405 will also send out a simple message to the string pattern matching engine 409, for example “cool down to 24 degree Celsius.” Then the system will post out a message to the chat server 419 through the knowledge database 411, the string response generator 413, and the NIC 415, and the network adaptor 417, for example “The thermostat will adjust the temperature down to 24 degree Celsius or 75 degree Fahrenheit.” This message will also be looped back to the sending system but will be neglected because the sending system knows the message is sent from itself.

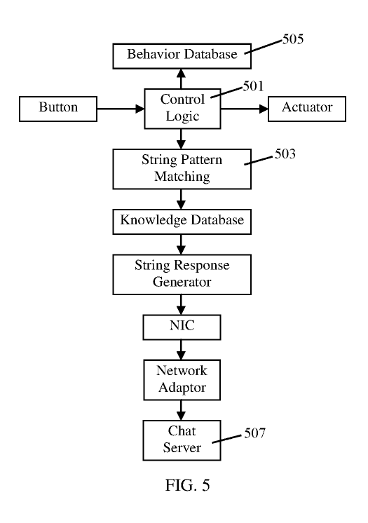

FIG. 5 illustrates that a message flow is initialized by a user via buttons in a system for instant messaging in accordance with an embodiment of the present patent application. Referring to FIG. 5, the message is initialized by the user via the buttons as input. This case is similar to the case in the previous embodiment, but triggered by a user button. The control logic unit 501 will send a simple message to the string pattern matching engine 503, for example, “set to 24 degree Celsius.” At the same time, the control logic unit 501 will update the parameters in the behavior database 505. Then the system (the control logic unit 50) will post out a message to the chat server 507, for example, “The thermostat was set to 24 degree Celsius or 75 degree Fahrenheit by user.” Another system in the network will understand that it is a goal set by a user input. Any loop back message from the sending system itself will be neglected.

FIG. 6 illustrates that a message flow is initialized by a chat terminal in communication with a system for instant messaging in accordance with an embodiment of the present patent application. Referring to FIG. 6, a user sends a message to a dedicate system, the system will respond with a message as an acknowledgement. If this message can generate a command, then the control logic unit 601 will perform a function at the actuator 603, update the behavior database 605, and send a simple message to the string pattern matching engine 617, for example, “require to turn off.” After that the system will post a message to the chat server 619, for example, “Air-conditioner will be turned off by the user.” If the received message cannot generate a command, the control logic unit 601 will send a simple message to the string pattern matching engine 607, for example, “send my functions.” Then the system will post a message to the chat server 609, for example, “Do you want to turn off, or up/down the temperature?”

In another case, when the user sends a message to the chat group (i.e. the chat server), if this message cannot generate a command, the system will not post any message out and keep silent; otherwise, it will perform its action using the parameters from the behavior database and post a message to the chat server. It is understood that any loop back message from the system itself will be neglected (i.e. dropped).

FIG. 7 illustrates that a message flow is initialized by an external information server in a system for instant messaging in accordance with an embodiment of the present patent application. Referring to FIG. 7, in this case, the message flow is initialized by an external information server via posting on the chat server. The info server 701 posts a message in the chat server 703 to share with the chat group. If this message cannot generate a command, then the system will keep silent without generating any response. In another case, if the message can generate a command then the system will perform an action using the parameters from the behavior database 705 and post a message to the chat server 703. It is understood that any loop back message from the system itself will be neglected (i.e. dropped). FIG. 8 is a flow chart illustrating the aforementioned different message types and message flows.

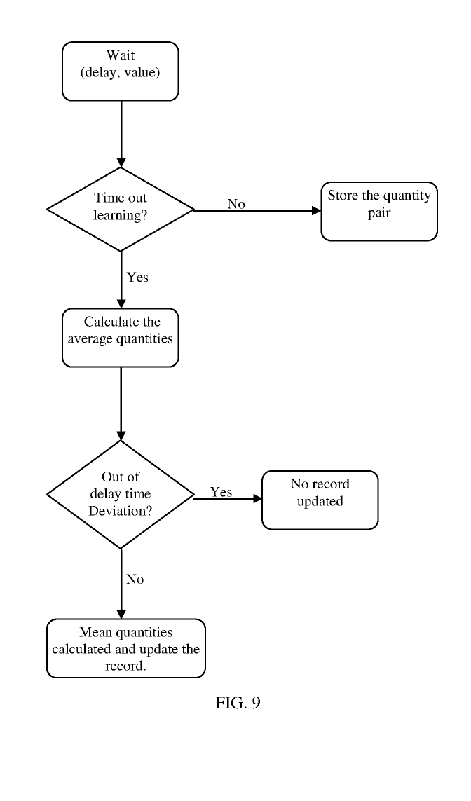

FIG. 9 is a flow chart illustrating an example of a curtain cooperating with a clock alarm enabled by a system for instant messaging in accordance with an embodiment of the present patent application. Referring to FIG. 9, one day, Harry (a user of the system) brings a new smart curtain installed in his bedroom, giving it the name Lily and let it join the group with the name “Bedroom”. The smart curtain has the following automatic functions:
1. to adjust its clock if the clock alarm reports the time in every hour; and
2. to open the curtain after the user stops the clock alarm.

Therefore, the smart curtain will find the clock alarm machine type in its assigned group and it finds three alarm clocks.

Lily uses its PIR and the PIR response from the group to identify its neighbor devices as well as to create a list to track them time from time. This know-how is a record in the knowledge database that includes the following: (script description is used hereafter instead of the real code for easily illustration):
a. Translation Key: has a value but not used in this illustration;
b. Input Templates: “User presents”, “User appears”, “User walks in”, etc.;
c. Matching Schemes: Phase matching method;
d. Contexts: Appear before three and after three messages when my PIR is triggered;
e. Response Templates: N/A (just listen)
f. Commands: Create or update the tracking list for the neighbor devices.

The knowledge design can be counted in-opposition so that first sensed will be last out. In this way, the record in the knowledge database includes the following:
a. Translation Key: has a value but not used in this illustration;
b. Input Templates: “User absent”, “User disappear”, “User walk out”, etc.
c. Matching Schemes: Phase matching method;
d. Contexts:—Appear before three and after three messages when my PIR is not triggered;
e. Response Templates: N/A (just listen)
f. Commands: Create or update the tracking list for the neighbor devices.

After that Lily detects a neighbor clock alarm called Peter and create a record in the behavior database for this cooperation. The record includes: (script description is used hereafter instead of the real code for easily illustration)
i. Group Name: Bedroom
ii. User Name: Harry
iii. Triggering Source: clock alarm, Peter
iv. Triggering Action: User stops the clock alarm
v. Weekday and weekend: N/A
vi. Time Section: N/A
vii. Last action time: N/A
viii. Response action: open the curtain
ix. Response action delay time: N/A
x. Response action value: 0%
xi. Time out of learning: 20 minutes
xii. Learning step size: per day

The above record with 0% of the “Response action value” means 0% of the curtain to open, that is, the curtain is still closed.

In Monday's morning, Harry first time stops the alarm clock (Peter) at 8:00 am for Lily and collects a message “Peter: alarm is stopped.” and Lily is triggered by this record in the knowledge database (referring to FIG. 6):
a. Translation Key: has a value but not used in this illustration
b. Input Templates: “stop alarm”, “am stopped”, “is stopped”, “User stops”, etc.
c. Matching Schemes: Phase matching method
d. Contexts: from alarm clock <Peter> (a template value)
e. Response Templates: “Open curtain <value>” (this string serves the control logic unit)
f. Commands: Open curtain with value.

Then the control logic unit receives this high-level command and looks up the record in the behavior database. Then it waits for 10 minutes to learn and pass a message “Open curtain 0%” to the chat engine. After that a record search in the knowledge database is done to post out a message to the chat server. The record includes:
a. Translation Key: has a value but not used in this illustration
b. Input Templates: “Open curtain”.
c. Matching Schemes: Phase matching method
d. Contexts: from Control logic unit
e. Response Templates: “I will open <value>.”, “Opening <value>.”, etc.
f. Commands: N/A.

In the chat engine, a new message is posted: “Lily: I will open 0%.” after the message “Peter: alarm is stopped.”

Three minutes later (within the time out of learning), Harry wants to open the curtain and he uses a switch to open the curtain around 50%. Then Lily updates the record of the behavior database after time out of learning. The record includes:
i. Group Name: Bedroom
ii. User Name: Harry
iii. Triggering Source: clock alarm, Peter
iv. Triggering Action: User stops the clock alarm
v. Weekday and weekend: Weekday
vi. Time Section: Morning
vii. last action time: 8:03 am
viii. Response action: open the curtain
ix. Response action delay time: 3 minutes
x. Response action value: 50%
xi. Time out of learning: 20 minutes
xii. Learning step size: per day

Lily will use a time-series average with robust statistics to continuously learn Harry's behavior (on response action delay and value parameters). The following is an illustration for this method using past three days' values.

### Monday

8:03 am—first time so the last three days value are initialized as

| | | Last-day | Yesterday | Today | Mean | Deviation |
|---|---|---|---|---|---|---|
| Response | Delay (min) | 3 | 3 | 3 | 3 | [0.30, 5.70] |
| action | Value (%) | 50 | 50 | 50 | 50 | N/A |

Where the mean value is calculated as the average of the values of the three days:

$$\begin{matrix}mean = \frac{Lastday + Yesterday + Today}{3} \\ = \frac{1}{3} Lastday + \frac{1}{3} Yesterday + \frac{1}{3} Today\end{matrix}$$

It is understood that other approaches may be used. For example, different weights may be applied to different days:

mean=0.2·Lastday+0.35·Yesterday+0.45·Today

and the Deviation is calculated as:

$$\begin{matrix}Deviation = [ ( mean - 0.9 \cdot mean ) , ( mean + 0.9 \cdot mean ) ] \\ = [ 0.1 \cdot mean , 1.9 \cdot mean ]\end{matrix}$$

Since the value is a boundary limited value, the Deviation will not be applied as outliner filtering in statistics.

The record of the behavior database will be updated with these mean values for the next day's action.

### Tuesday

The alarm stops again at 8:00 am and after 3 minutes Lily opens the curtain 50%.

At 8:03.25, Harry opens the curtain 100%. After the time out of learning (20 minutes), the average quantities (3.25, 100%) are calculated within the 20 minutes. Since the delay time 3.25 is within its Deviation, the table is updated and mean values are calculated. The record of the behavior database will be updated with these mean values for next day action.

| | | Last-day | Yesterday | Today | Mean | Deviation |
|---|---|---|---|---|---|---|
| Response | Delay | 3 | 3 | 3.25 | 3.08 | [0.31, |
| action | (min) | | | | | 5.85] |
| | Value | 50 | 50 | 100 | 67% | N/A |
| | (%) | | | | | |

### Wednesday

The alarm stops again at 8:00 am after 3.08 minutes and Lily opens the curtain 67%.

At 8:10, Harry closes the curtain at 0%. After the time out of learning (20 minutes), the average quantities (10, 0%) are calculated within the 20 minutes. Since the delay time 10 minutes is out of its Deviation so the table and the record of the Behavior Database won't be updated.

### Thursday

The alarm stops at 8:10 am and after 3.08 minutes Lily opens the curtain 67%.

At 8:14, Harry closes the curtain at 0%. At 8:17, Harry re-opens the curtain at 100%. After the time out of learning (20 minutes), the average of quantities (5.5, 50%) are calculated within the 20 minutes. Since the delay time 5.5 is within its Deviation so the table is updated and mean values are calculated.

| | | Last-day | Yesterday | Today | Mean | Deviation |
|---|---|---|---|---|---|---|
| Response | Delay | 3 | 3.25 | 5.5 | 3.92 | [0.39, |
| action | (min) | | | | | 7.44] |
| | Value | 50 | 100 | 50 | 67% | N/A |
| | (%) | | | | | |

FIG. 10 is a block diagram of a system for instant messaging in accordance with an embodiment of the present patent application. Referring to FIG. 10, the system for instant messaging includes at least a user terminal 1011 and at least a machine 1021. Each user terminal 1011 and each machine 1021 are respectively installed with an instant messaging client. The user terminal 1011 and the machine 1021 communicate with each other by their respective instant messaging clients through instant messaging.

The system for instant messaging may include a plurality of machines and/or a plurality of user terminals. When the system includes a plurality of machines, the machines communicate with each other by their respective instant messaging clients through instant messaging. For example, an electronic fan in the living room may communicate with another electronic fan in the dining room through instant messaging. A microprocessor of small size and high performance may be installed on the machine. The microprocessor may run the instant messaging client installed on the machine.

The machine may be a home appliance such as a food processing machine, a refrigerator or an air conditioner. The machine may be an office appliance such as a printer. The machine may be a mechanical apparatus such as a milling machine, or a transportation tool such as an automobile or an airplane.

Each machine has a unique identification code coming out of the factory, by which the machine can register or log into the instant messaging client, just like a user used an ID and password to register and log into the instant messaging client. For the instant messaging client, both machine and user are the object if instant messaging.

The user terminal may communicate with the machine through WiFi, Bluetooth, or a mobile network wirelessly, or by a physical wire. The user terminal and the machine can be installed with a WiFi module, a Bluetooth module, or a wireless module for installing a SIM card and communicating through a mobile network.

The instant messages between the user terminal and the machine and between the machines may be communicated in the form of binary data. The binary data may be text based messages, such as a text message between a user and a machine. The binary data may also be images, audios, or videos. The binary data may represent human natural language symbols. The human natural language symbols being represented by the binary data may be 16 bit unicodes, instead of 8-bit binary text data. The human natural language symbols may include English or Chinese symbols, or combinations of multiple language symbols.

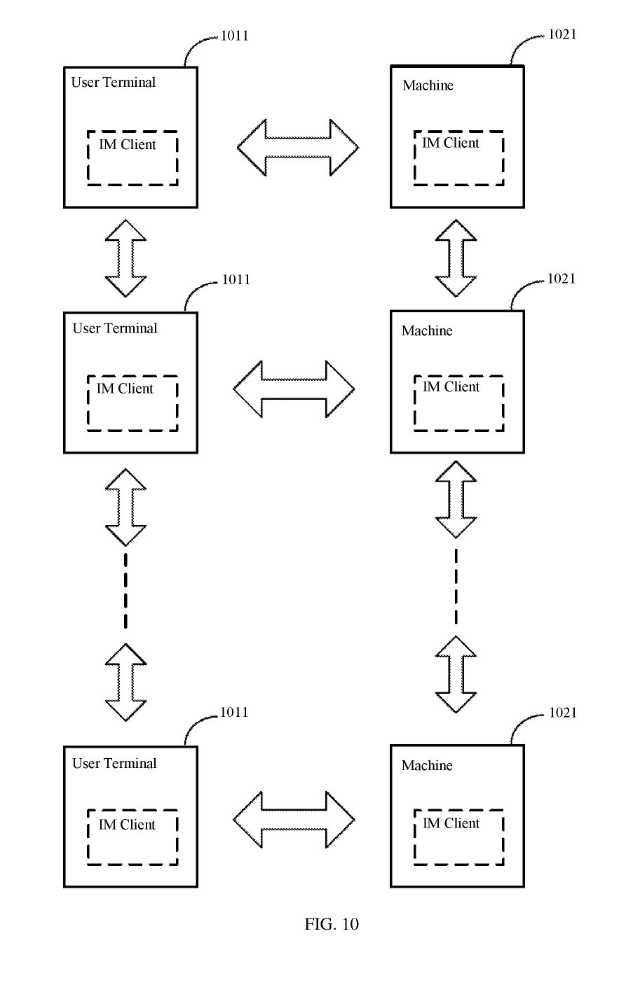

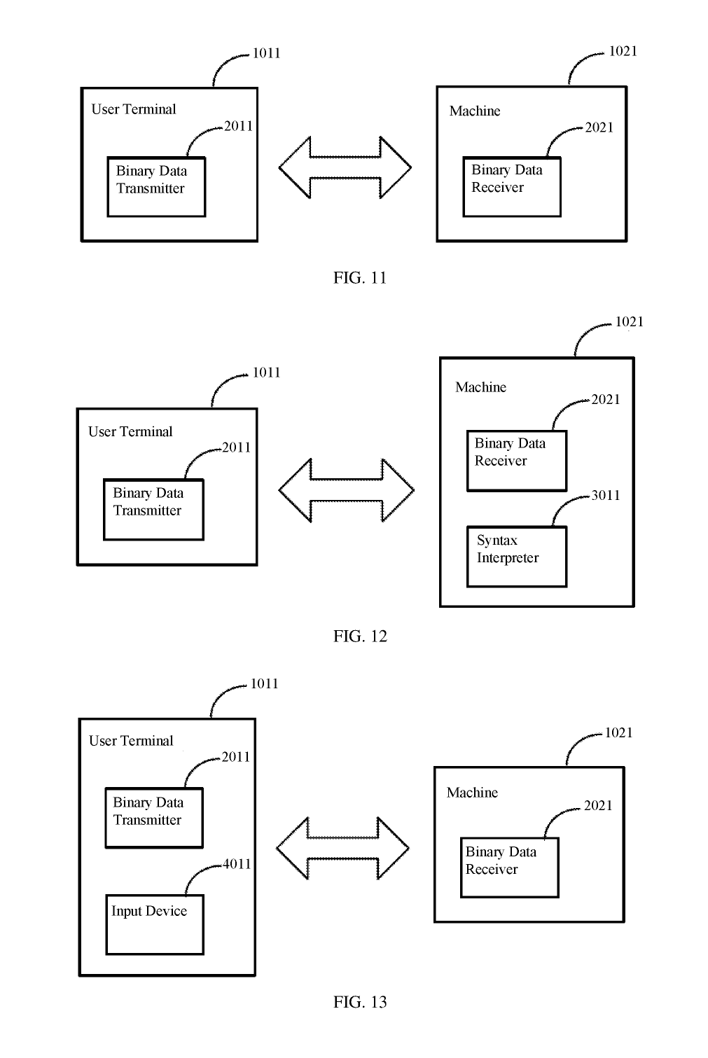

FIG. 11 is another block diagram of a system for instant messaging in accordance with an embodiment of the present patent application. Referring to FIG. 11, the user terminal 1011 includes: a binary data transmitter 2011 configured to transmit binary data to the machine 1021 by the instant messaging client of the user terminal 1011. The machine 1021 includes: a binary data receiver 2021 configured to receive binary data from the user terminal 1011 by the instant messaging client of the machine 1021.

Each machine may include a binary data transmitter configured to transmit binary data to another machine by the instant messaging client of the machine; and a binary data receiver configured to receive binary data from another machine by the instant messaging client of the machine.

After the machine receives the binary data, the machine may feed the binary data to a syntax interpreter. FIG. 12 is another block diagram of a system for instant messaging in accordance with an embodiment of the present patent application. Referring to FIG. 12, in this embodiment, the machine 102 further includes a syntax interpreter 3011 configured to interpret syntax of the binary data received by the binary data receiver 2021, and retrieve abstract meaning of text represented by the binary data.

For the user terminal, before the binary data transmitter transmits binary data, the message to be transmitted is required to be converted to binary data. The message may be text input by a user, or audio input by a user. FIG. 13 is another block diagram of a system for instant messaging in accordance with an embodiment of the present patent application. Referring to FIG. 13, in this embodiment, the user terminal 101 further includes an input device 401 configured to allow a user to input text or audio. The binary data transmitter 2011 is configured to transmit binary data converted from the text or audio input by the user.

When the user terminal communicates with the machine, a chat record between the user and the machine will be generated. The user terminal is configured to transmit a request to the machine, and the machine is configured to automatically generate a response message responding to the request, without human intervention.

The machine is configured to learn from history data transmitted from the user terminal through an artificial intelligence engine, and automatically generate a response message responding to the request. In the process of learning, the artificial intelligence engine is configured to analyze the history data, and calculate and generate a more appropriate response message so as to gradually improve the user experience. The machine learning can even predict the likes of the user, which is good for improving control of the machine operation.

Before the user terminal communicates with the machine, the user and the machine can register each other, just like adding each other as friends. The user can register the machine through the instant messaging client of the user terminal, while the machine can register the user through the instant messaging client of the machine. The user and the machine thereby add each other as “friends”, which makes instant messaging between the user and machine a lot more convenient.

A user may register with a plurality of machines. As aforementioned, the machine may be a home appliance such as a food processing machine, a refrigerator or an air conditioner. The machine may be an office appliance such as a printer. The machine may be a mechanical apparatus such as a milling machine, or a transportation tool such as an automobile or an airplane.

A user may register other users by the instant messaging client of the user terminal. The machine may register the other machine through the instant messaging client of the machine. This way, different users and different machines can add each other as “friends”, which makes instant messaging between them more convenient.

In some scenarios, a user terminal can be used by multiple users. Suppose a first user terminal is a user terminal with multiple users. After a first user of the first user terminal logs in the instant messaging client of the first user terminal, the first user terminal sends a message to a second user terminal indicating that the user is one of multiple users of the first user terminal. A second user of the second user terminal is registered with the first user who logs into the first user terminal. The second user of the second user terminal is notified by the message of lack of privacy of the first user terminal.

For example, a first user terminal A has users 1, 2, and 3, while a second user terminal B has a user 4. The user 1 is preregistered with the user 4, i.e. the user 1 has been added by the user 4 as a friend. When the user 1 is logged in to the first terminal A, the first terminal A is configured to send a message to the second user terminal B, indicating that the user 1 is one of the multiple users of the first user terminal A, and by receiving the message, the user 4 of the second user terminal B is notified that the first user terminal A lacks privacy. The user 4 can use the second user terminal B to send a message to other users and thereby notifying them that the first user terminal A lacks privacy. The message may include title and content that can be seen by the other users.

In this embodiment, the system for instant messaging may include a third device that is connected between a user terminal and a machine or between one machine and another machine and configured to assist and facilitate the communication between them. For example, the third device may be a protocol language translation engine device configured to translate protocol language of data transmitted to the user terminal or the machine, when the data is not recognized by the user terminal or the machine during communication between the user terminal and the machine or between the machines. The system for instant messaging may include one or multiple protocol language translation engine devices. The protocol language translation engine device is configured to translate may include Zigbee protocol, Bluetooth protocol, and other protocols.

For example, when a user terminal A communicates with a machine B, while both the user terminal A and the machine B cannot recognize data transmitted by the other side. The protocol language translation engine device C is connected between the user terminal A and the machine B, and configured to translate the data transmitted by the user terminal A into data that can be recognized by the machine B, and send the translated data to the machine B; and to translate the data transmitted by the machine B into data that can be recognized by the user terminal A, and send the translated data to the user terminal A. Communication between the user terminal A and the machine B is thereby established through the protocol language translation engine device C.

In this embodiment, the protocol language translation engine device may include a transceiver configured to, during communication between the user terminal and the machine or between the machines, receive data transmitted by one side, and transmit protocol language translated data to the other side.

In addition to that multiple users can form a group by the instant messaging client, multiple machines can form a group by the instant messaging client, while machines and users can also form a group by the instant messaging client, thereby realizing instant messaging between group members.

When a protocol language translation engine device is included in the system for instant messaging, at least one user terminal, the at least one machine, and the at least one protocol language translation engine device form a plurality of device groups. Different device groups can communicate with each other. Each device group includes a group of main devices. Different groups of main devices are configured to communicate with each other. For example, a device group in the living room may communicate with another device group in the bedroom.

In this embodiment, a device in each device group is connected with an external cloud server, and configured to communicate with other device groups through the Internet. For example, a device group in Asia may communicate with another device group in USA.

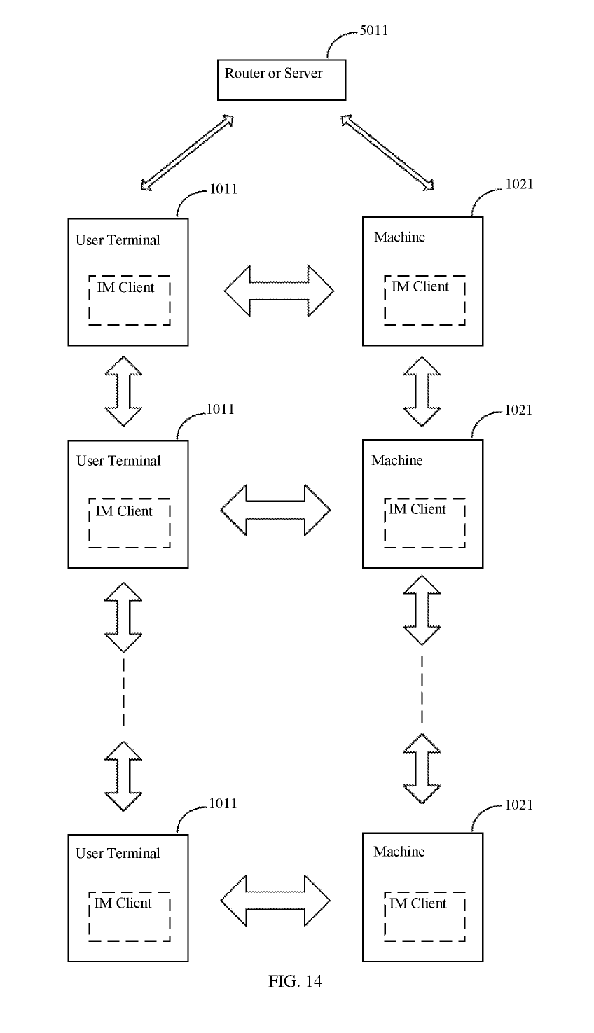

FIG. 14 is another block diagram of a system for instant messaging in accordance with an embodiment of the present patent application. Referring to FIG. 14, the system for instant messaging may further include a router or a server 5011 configured to collect response of the at least one machine 1021 to the user terminal 1011. The user terminal 1011 is configured to check and verify the response of the machine 1021 to the user terminal 1011 by logging into the router or server 5011.

In this embodiment, the router may be a mini router for home use. The router or server is configured to collect responses of all machines so that a user can check and verify a comprehensive results of the responses of all machines by logging into the router or server wirelessly or by wire with the user terminal.

The user terminal is configured to modify the response of the machine to the user terminal by logging into the router or server. The router or server is configured to notify the machine of the response modified by the user terminal. The modification and calibration to the response of the machine made by the user can make the operation of the machine better meet the user's requirements.

The system for instant messaging may further include a LED indicator configured to indicate status of the machine. The user may get to know the operation status of the machine by observing the LED indicator.

The system for instant messaging may further include a buzzer and a microphone configured to transmit and receive ultrasound, and form ultrasound communication links between multiple machines by ultrasound. For example, in a kitchen, a bedroom, or other space for short distance wireless communication, ultrasound communication links may be formed between machines, especially home appliances, by ultrasound.

In above embodiments, the system for instant messaging realizes communication between human and machine and communication between machines through instant messaging, and achieves real time monitoring and even real time control of operation of machines by human or machine.

While the present patent application has been shown and described with particular references to a number of embodiments thereof, it should be noted that various other changes or modifications may be made without departing from the scope of the present invention.

What is claimed is:

1. A network comprising:
at least a user terminal;
a chat server; and
at least a system for instant messaging, the system comprising:
a processor;
memory;
a chat engine;
a control logic unit; and
an input and output interface; wherein:
the user terminal, the chat server, and the system are in communication with each other through instant messaging;
a first user terminal is configured to send a message to a second user terminal indicating lack of privacy of the first user terminal when a first user of the first user terminal is logged in to the first user terminal, the first user being preregistered with a second user of the second user terminal; and
the second user terminal is configured to send a message to a third user and thereby notifying the third user of the lack of privacy of the first user terminal.

2. The network of claim 1, wherein the system further comprises a behavior database, while the input and output interface comprises a network interface connection and at least one of a sensor, an actuator, a button and a display; the control logic unit is configured to perform a function through the input and output interface and update parameters in the behavior database.

3. The network of claim 1, wherein the system further comprises a web server, wherein the web server is configured to provide a web format page for detail reporting or summary.

4. The network of claim 2, wherein the chat engine comprises a string pattern matching, a string response generator, a command generator and a knowledge database.

5. The network of claim 4, wherein the string pattern matching engine is an input engine configured to match an input entity of the knowledge database, while the string response generator is configured to generate a human comprehendible response based on an output of the knowledge database.

6. The network of claim 4, wherein the command generator is configured to generate a high-level command based on an output of the knowledge database and send the high-level command to the control logic unit.

7. The network of claim 6, wherein the control logic unit is configured to accept the high-level command from the command generator, and to control the system with parameters in the behavior database.

8. The network of claim 7, wherein the behavior database is initially filled with default values, and then updated to be tracking behavior of a user or another system in the network.

9. The network of claim 4, wherein the knowledge database comprises a plurality of records, each record having attributes that comprise: Translation Key, Input Templates, Matching Schemes, Contexts, Responses Templates, and Commands.

10. The network of claim 4, wherein the behavior database comprises a plurality of records, each record having attributes that comprise: Group Name, User Name, Triggering Source, Triggering Action, Weekday and weekend, Time Section, Last action time, Response action, Response action delay time, Response action value, Time out of learning, and Learning step size.

11. The network of claim 1, wherein after the control logic posts a message to the chat server, the system is configured to neglect the message sent by itself.

12. The network of claim 2, wherein when a user sends a message to the system, the system is configured to respond with a message as an acknowledgement.

13. The network of claim 12, wherein if the message can generate a command, the control logic unit is configured to perform a function at the actuator, update the behavior database, and send a simple message to the string pattern matching engine; if the received message cannot generate a command, the control logic unit is configured to send a simple message to the string pattern matching engine so as to generate a command option message to remind the user.

14. The network of claim 2, wherein when a user sends a message to the chat server, if the message cannot generate a command, the system is configured to not post any message and keep silent; otherwise, the system is configured to perform its action using parameters in the behavior database and post a message to the chat server.

15. A system for instant messaging, the system comprising:
a chat engine;
a control logic unit;
a behavior database; and
an input and output interface; wherein:
the control logic unit is configured to perform a function through the input and output interface and update parameters in the behavior database;
the chat engine comprises a string pattern matching, a string response generator, a command generator and a knowledge database;
the string pattern matching engine is an input engine configured to match an input entity of the knowledge database, while the string response generator is configured to generate a human comprehendible response based on an output of the knowledge database;
the command generator is configured to generate a high-level command based on an output of the knowledge database and send the high-level command to the control logic unit; and
the control logic unit is configured to accept the high-level command from the command generator, and to control the system with parameters in the behavior database.

16. The system of claim 15, wherein the knowledge database comprises a plurality of records, each record having attributes that comprise: Translation Key, Input Templates, Matching Schemes, Contexts, Responses Templates, and Commands.

17. The system of claim 15, wherein the input and output interface comprises a network interface connection and at least one of a sensor, an actuator, a button, and a display.

18. A method for instant messaging, the method comprising:
matching an input entity of a knowledge database by a string pattern matching engine;
generating a human comprehendible response based on an output of the knowledge database by a string response generator;
generating a high-level command based on an output of the knowledge database and sending the high-level command to a control logic unit by a command generator; and
accepting the high-level command from the command generator, performing a function through an input and output interface with parameters in a behavior database, and updating parameters in the behavior database by the control logic unit.

19. The method of claim 18 further comprising initially filling the behavior database with default values, and then updating the behavior database to track behavior of a user.

20. The method of claim 18, wherein the behavior database comprises a plurality of records, each record having attributes that comprise: Group Name, User Name, Triggering Source, Triggering Action, Weekday and weekend, Time Section, Last action time, Response action, Response action delay time, Response action value, Time out of learning, and Learning step size.

21. A system for instant messaging comprising:
at least a user terminal; and
at least a machine; wherein:
each user terminal and each machine are respectively installed with an instant messaging client; and
the user terminal and the machine are configured to communicate with each other by their respective instant messaging clients through instant messaging.

22. The system of claim 21 comprising a plurality of machines, wherein the machines are configured to communicate with each other by their respective instant messaging clients through instant messaging.

23. The system of claim 21, wherein the user terminal comprises a binary data transmitter configured to transmit binary data to the machine by the instant messaging client of the user terminal; the machine comprises a binary data receiver configured to receive binary data from the user terminal by the instant messaging client of the machine.

24. The system of claim 23, wherein the user terminal further comprises an input device configured to allow a user to input text or audio; the binary data transmitter is configured to transmit binary data converted from the text or audio input by the user.

25. The system of claim 22, wherein each machine comprises a binary data transmitter configured to transmit binary data to another machine by the instant messaging client of the machine; and a binary data receiver configured to receive binary data from another machine by the instant messaging client of the machine.

26. The system of claim 25, wherein the machine further comprises a syntax interpreter configured to interpret syntax of the binary data received by the binary data receiver, and retrieve abstract meaning of text represented by the binary data.

27. The system of claim 25, wherein the binary data represents human natural language symbols.

28. The system of claim 27, wherein the human natural language symbols are 16 bit unicodes.

29. The system of claim 27, wherein the human natural language symbols comprise English or Chinese symbols.

30. The system of claim 21, wherein when the user terminal communicates with the machine, the user terminal is configured to transmit a request, and the machine is configured to automatically generate a response message responding to the request.

31. The system of claim 30, wherein the machine is configured to learn from history data transmitted from the user terminal through an artificial intelligence engine, and automatically generate a response message responding to the request.

32. The system of claim 21, wherein before the user terminal communicates with the machine, a user registers the machine through the instant messaging client of the user terminal, and the machine is configured to register the user through the instant messaging client of the machine; before the machine communicates with another machine, the machine is configured to register the other machine through the instant messaging client of the machine.

33. The system of claim 32, wherein the instant messaging client of the user terminal is configured to allow the user to register other users.

34. The system of claim 33, wherein a first user terminal is a user terminal with multiple users; after a first user of the first user terminal logs in the instant messaging client of the first user terminal, the first user terminal is configured to send a message to a second user terminal indicating that the first user is one of the multiple users of the first user terminal; a second user of the second user terminal is registered with the first user of the first user terminal; the second user of the second user terminal is notified by the message of lack of privacy of the first user terminal.

35. The system of claim 21 further comprising a router or a server configured to collect response of the at least one machine to the user terminal, wherein the user terminal is configured to check and verify the response of the machine to the user terminal by logging into the router or server.

36. The system of claim 35, wherein the user terminal is configured to modify the response of the machine to the user terminal by logging into the router or server; the router or server is configured to notify the machine of the response modified by the user terminal.

37. The system of claim 21 further comprising a LED indicator configured to indicate status of the machine.

38. The system of claim 22 further comprising a buzzer and a microphone configured to transmit and receive ultrasound, and form ultrasound communication links between the machines by ultrasound.

39. The system of claim 21, wherein the user terminal is configured to communicate with the machine through WiFi, Bluetooth, or a mobile network wirelessly, or by a physical wire.

40. The system of claim 21, wherein the machine is a home appliance, office appliance, mechanical apparatus or a transportation tool.

41. The system of claim 21 further comprising at least a protocol language translation engine device configured to translate protocol language of data transmitted to the user terminal or the machine, when the data is not recognized by the user terminal or the machine during communication between the user terminal and the machine or between the machines.

42. The system of claim 41, wherein the protocol language translation engine device comprises a transceiver configured to, during communication between the user terminal and the machine or between the machines, receive data transmitted by one side, and transmit protocol language translated data to the other side.

43. The system of claim 41, wherein the at least one user terminal, the at least one machine, and the at least one protocol language translation engine device form a plurality of device groups; each device group comprises a group of main devices; different groups of main devices are configured to communicate with each other.

44. The system of claim 43, wherein a device in each device group is connected with an external cloud server, and configured to communicate with other device groups through the Internet.

45. The system of claim 41, wherein protocols that the protocol language translation engine device is configured to translate comprise Zigbee protocol and Bluetooth protocol.
